(19) United States
(12) Patent Application Publication
(10) Pub. No.: US 2004/0126560 A1
(43) Pub. Date: Jul. 1, 2004

(54) Laminated polyethylene foam product

(75) Inventors: Maurizio Brandolini, Milano (IT); Derek Hargreaves, Northamptonshire (GB); Natarajan S. Ramesh, Grapevine, TX (US); Battista Casula, Verderio Inferiore (IT); Eric Grills, Ontario (CA); Lloyd George, Barnstable, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 10/330,625

(22) Filed: Dec. 27, 2002

(51) Int. Cl. B32B 3/26

(52) U.S. Cl. 428/308.4; 428/304.4

(57) ABSTRACT

A thick-sheet foam laminate and a method of making the foam laminate comprising at least two polyethylene foam layers laminated together by heat adhesion, wherein at least one of the layers has a thickness of ¾-inch and greater.

### FIELD OF THE INVENTION

The invention relates to the production of laminated polyethylene foam products, and relates more particularly to a method for producing laminated polyethylene foam products having improved compression characteristics.

### BACKGROUND OF THE INVENTION

Foamed products, which find use as packaging, cushioning, insulating and structural materials, typically consist of a phase of open or closed pores or cells dispersed throughout a polymer matrix. A wide array of processes have been devised for developing the cell phase in these products, including adding a gaseous “blowing agent” to the polymer during processing, producing a gaseous blowing agent by chemical reaction within the polymer during processing, and forming the product from polymer granules to obtain a cellular structure.

A gaseous blowing agent can be incorporated into a molten thermoplastic material under pressure to form a mixture that can then be extruded to a zone of lower pressure and expanded to a desired shape. Reduced pressure causes the blowing agent to expand, forming a cellular structure within the thermoplastic matrix. Shaped extruded foams can be produced by this method using a forming die of particular configuration. Foam sheets are produced in this manner.

Thin sheets are generally less than ½-inch, and even less than ¼-inch in thickness. Foams are typically considered to be thick foams if they have a thickness of ½-inch or greater. Thick foams can be used for a variety of purposes, including building materials, rigid structural members, and insulation.

Thick foams are often constructed by laminating two or more layers of foam sheet together. Foam products with thicknesses of 1 inch to 10 inches or so are typically constructed of laminated ½-inch foam layers. Half-inch foam is the preferred foam for use in lamination because the ½-inch foam is readily available and is often produced with more consistent densities, cell formation, and structural properties than comparable extruded foam layers of greater than ½-inch in thickness. Further, it is easier to evacuate blowing agents from thin foams than thicker foams, so thin foams may be produced much faster and cheaper than thick foams.

Foam laminates may not be desirable in certain situations because they often have reduced compression strength in comparison to solid foam planks of comparable thickness. Also, foam laminates exhibit inelastic behavior upon initial loading in contrast to some solid foam planks that exhibit simple elastic or linear elastic behavior. The inelastic behavior of the laminates is undesirable when the foam is used for structural or cushioning purposes.

It is desired to create a foam structure having the favorable economic and foam formation characteristics of a laminate but having compressive strength and elastic initial loading characteristics of a solid foam plank.

### SUMMARY OF THE INVENTION

The invention is a foam laminate and a method of making a foam laminate comprising at least two polyethylene foam layers, wherein at least one of the layers has a nominal thickness of at least ¾-inch and the laminate has linear-elastic properties upon initial loading.

It has been found that, for any given thickness of a heat-laminated foam laminate, compressive strength is improved when the layers of the laminate are fewer in number and greater in thickness compared to otherwise similar laminates having a greater number of thinner foam layers. The improved compressive strength is more noticeable as the thickness of the individual foam layers is increased and further as the overall thickness of the laminate is increased.

In the case of polyethylene foam, a thick-sheet laminate is formed by heat-laminating foam layers wherein at least one of the layers has a thickness of ¾-inch, and wherein the laminate has a total thickness of about 1½ to 10 inches and an average density of 1.2 lb/ft³-7.5 lb/ft³. This thick-sheet laminate has improved physical properties compared to polyethylene foam laminates comprising individual foam layers with thicknesses of ½ inch or less. The physical properties of the thick-sheet laminate of the invention, particularly the overall compression strength, is greater than typical laminates of ½-inch polyethylene foam layers. The compression strength of the thick-sheet sheet laminate increases as the thickness of the individual layers is increased, as the density of the foam is increased, and as the number of layers within the laminate having thickness of greater than ¾-inch is increased. The increased compression strength is not found in ½-inch laminates of the past.

It has also been found that a foam laminate may exhibit elastic deformation upon initial loading if one or more layers of the laminate have a thickness greater than a minimum threshold thickness. Threshold thickness may depend upon the specific composition of the polyethylene foam material from which the laminate is constructed, the number of layers within the laminate, and the density of the foam layers. In general, polyethylene foam laminates having at least one foam layer of ¾-inch and greater thickness exhibit elastic deformation upon initial loading.

Useful polyethylene resins include polyethylene homopolymers, such as low-density polyethylene (LDPE), linear low-density polyethylene (LLDPE), and high-density polyethylene (HDPE). Useful polyethylene resins also include polyethylene copolymers, such as homogeneous ethylene/alpha-olefin copolymers, heterogeneous Ziegler-Natta catalyzed ethylene/alpha-olefin copolymers, and ethylene vinyl acetate (EVA) copolymers.

The thick-sheet laminate exhibits elastic behavior upon initial loading. The threshold thickness is about ¾-inch for elastic behavior in the heat-laminated foam laminates with density of 1.2 lb/ft³ to 7.5 lb/ft³, and at least one of the foam layers must meet or exceed this threshold thickness. The range of elastic compression increases when the thickness of the individual layers is increased, as the density of the foam is increased, and as the number of layers within the laminate having thickness of ¾-inch and greater is increased.

With elastic behavior, the cell walls within the foam bend upon compression at initial loading and recover completely upon removal of the load. Elastic compression of up to 7.5% or more of the thickness of the laminate may be achieved. In general, the total percentage of elastic compression increases with the thickness of the foam layers. For instance, foam layers of about ¾-inch provide the laminate with a threshold level of elastic compression, up to about 5%, while foam layers of 1-inch nominal thickness may provide 7.5% or greater elastic compression, based upon the total thickness of the laminate.

Elastic behavior may find particular usefulness in the packaging of heavy objects. It is not uncommon for a heavy object to compress a foam laminate when placed on the laminate. Compression caused by the weight of a heavy object is typically up to 5% of the laminate thickness, but may be greater depending upon the particular laminate and the weight of the object. The laminate will remain intact if the laminate has elastic behavior over the range of compression caused by the heavy object. Thus, the laminate will completely recover upon removal of the heavy object. The ability to completely recover from initial loading is not found in previous foam laminates, such as those prepared from ½ inch foam sheets.

In contrast to the thick-sheet laminates, traditional foam laminates constructed of thinner foams exhibit a substantially linear relationship between percent compression and compression strength. The linear relationship provides generally favorable compression characteristics. However, these laminates have no yield point (no region of elastic deformation) and poor compression strength upon initial loading. Because the laminates are unable to deform elastically under initial loading, they must deform by the plastic bending of the cell walls, which leads to cell rupture and degradation of the foam. Heretofore, poor compression strength at initial loading is not believed to have been investigated and has been accepted as a property of the foam laminates.

Though not wishing to be bound by theory, it is believed that previous laminates exhibit plastic or permanent deformation upon initial loading due to the formation of plastic hinges at the section of maximum moment during compression which eventually leads to cell rupture due to brittleness of the cell wall. In contrast, the thicker foam sheets are produced under conditions of low shear compared to thinner sheets. The lower shear results in a lower percentage of open cells. When two or more of the thicker foam layers are heat laminated together, a laminate having improved compression characteristics is formed.

The thick-sheet laminate also exhibits superior creep resistant qualities compared to otherwise similar laminates formed with thinner foam layers. Creep is the condition of thickness loss after long-term compression, and foam laminates having lower creep percentages are preferred.

The thick-sheet laminate is well suited for uses that benefit from the laminate's improved compression characteristics. As mentioned, the laminates are well suited for packaging of heavy objects that compress the laminate. The laminate also finds usefulness in applications that repeatedly compress the laminate. Repeated compression is destructive to the foam structure of most laminates, but the elastic nature of the thick-sheet laminate allows the thick-sheet laminate to remain intact after repeated compression.

The increased compression strength and the elastic compression characteristics of the thick-sheet laminate are quite unexpected and are not found in foam laminates produced with foam layers below the threshold thickness. For instance, laminates of ½-inch to ⅝-inch foam layers exhibit no elastic compression characteristics, and it would have previously been unexpected that increased layer thickness would transform the initial loading behavior of the laminate from plastic to elastic.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a cross-section view of a foam laminate according to an embodiment of the invention;

FIG. 2 is a cross-section view of a foam laminate according to another embodiment of the invention;

FIG. 3 is a cross-section view of a 2-inch laminate formed from ½-inch foam layers;

FIG. 4 is a cross-section view of a 2-inch laminate formed from 1-inch foam layers according to another embodiment of the invention;

FIG. 5 is a graph comparing compressive strength of various 2-inch foam laminates;

FIG. 6 is a cross-section view of a 4-inch laminate formed from ½-inch foam layers;

FIG. 7 is a cross-section view of a 4-inch laminate formed from 1-inch foam layers according to another embodiment of the invention;

FIG. 8 is a graph comparing compressive strength of various 4-inch foam laminates;

FIG. 9 is a cross-section view of a 4-inch laminate formed from ½-inch and 1-inch foam layerss according to another embodiment of the invention;

FIG. 10 is a graph comparing the compressive strength of various 4-inch foam laminates;

FIG. 11 is a cross-section view of a 6-inch laminate formed from ½-inch foam layers;

FIG. 12 is a cross-section view of a 6-inch laminate formed from 1-inch foam layers according to another embodiment of the invention; and

FIG. 13 is a graph comparing the compressive strength of 6-inch foam laminates.

### DETAILED DESCRIPTION OF THE INVENTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

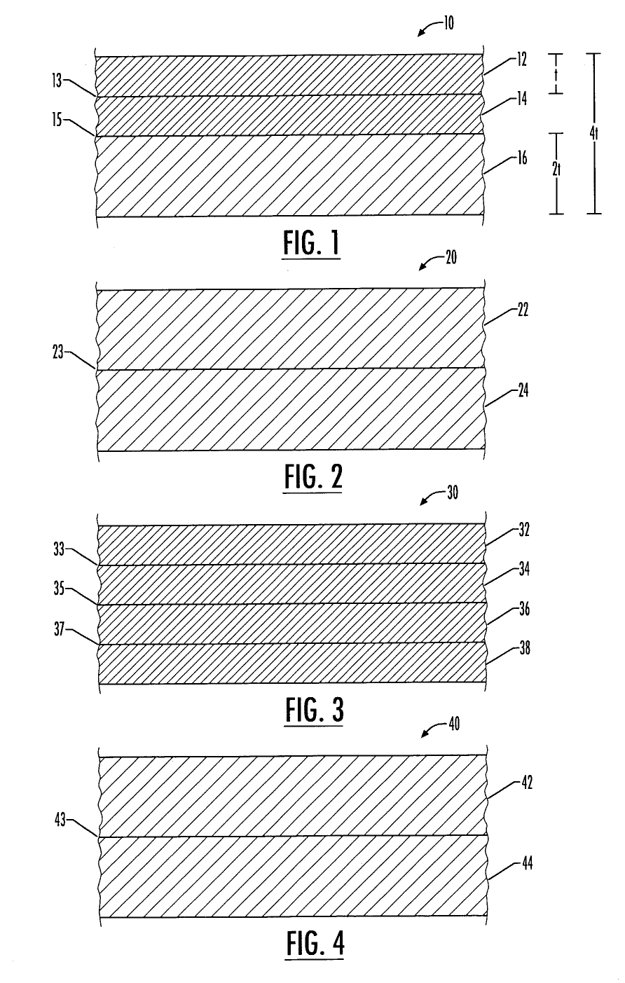

Referring to FIG. 1, an exemplary thick-sheet laminate is shown having a first foam layer 12 of thickness t, a second foam layer 14 of thickness t, and a third foam layer 16 of thickness 2 t which is about ¾-inch or greater. The three foam layers are layered to form a laminate having a total thickness 4 t. Each of the foam sheets 12, 14, 16 is formed of a similar density low density polyethylene (LDPE) foam, though it should be recognized that other resins may be used in the practice of the invention. The foam layers are heat-laminated to one another such that the first and second layers 12, 14 are joined at an interface 13, and the resulting laminate of the first and second layers is joined at an interface 15 with the third layer 16.

Referring to FIG. 2, another exemplary thick-sheet laminate is shown having a first foam layer 22 of thickness 2 t, and a second foam layer 24 of thickness 2 t where both foam layers 22, 24 have a thickness of about ¾-inch or greater. The two layers 22, 24 are layered to form a laminate having a total thickness of 4 t. Each of the foam layers 22, 24 is formed of a common density LDPE foam that are heat laminated at an interface 23.

The foams used in the laminate are polyethylene foams. Polyethylene is a whitish, translucent polymer of moderate strength and high toughness that is available in forms ranging in crystallinity from 35 to 95 percent. Useful polyethylene resins include polyethylene homopolymers and copolymers. Useful polyethylene homopolymers include low-density polyethylene (LDPE), linear low-density polyethylene (LLDPE), and high-density polyethylene (HDPE). Polyethylene copolymers may include homogeneous ethylene/alpha-olefin copolymers, such as matallocene/single-site catalyzed copolymers of ethylene and one or more C₃ to C₁₀ alpha-olefin comonomers, or heterogeneous Ziegler-Natta catalyzed ethylene/alpha-olefin copolymers. Other ethylene copolymers include propylene, higher olefins and carboxylic acids and esters. Various ethylene copolymers are used in which the second comonomer is a carboxylic acid or ester such as vinyl acetate, acrylic acid, methacrylic acid, methacrylate and ethyl acrylate. Ethylene vinyl acetate (EVA) copolymers with vinyl acetate content ranging up to 30% weight could be used. LDPE is typical of the polyethylenes used in foam production and is used as the exemplary polyethylene throughout this disclosure.

As an exemplary method of creating the foam layers, solid pellets of LDPE are conveyed from a hopper through a melt zone in which the resin is melted, or plasticized, to form a flowable thermoplastic mass. The mass is then metered to the mixing zone of a screw extruder, which can be a single screw extruder or double screw extruder, which includes twin screw and tandem screw extruders. In the mixing zone, the LDPE is thoroughly mixed with a blowing agent under pressure.

When a blowing agent is injected into the mixing zone of the screw extruder, the blowing agent initially forms a dispersion of insoluble bubbles within the plasticized LDPE mass. These bubbles eventually dissolve in the thermoplastic mass as the mixing continues and the pressure increases down the length of the extruder. The extruder should have a length to diameter ratio of at least 30:1 and a sufficient length of mixing zone to ensure that proper mixing occurs.

The resin is maintained at a temperature within a range above the melting point of the polymer that is sufficiently high so that the polymer has sufficient fluidity for mixing with blowing agent. This range is from about 20° C. to 100° C. above the melting point of the resin. The melting zone can be maintained at a somewhat lower temperature due to the heat that is generated by friction as the plasticized resin flows through the extruder.

After mixing, the temperature of the mixture of resin and blowing agent should be lowered closer to the melting point of the mixture so that the polymer maintains its structure upon foaming, but not so much that complete expansion is hindered. The blowing agent has a plasticizing effect on the resin reducing its viscosity, or resistance to flow, and so the melting point of the mixture of resin and blowing agent normally is below that of the resin alone. The expansion temperature, which is above the melting point of the mixture, is empirically determined and depends upon the composition of the resin, the length of the screw, whether single or double screws are used, on the specific resin, upon the amount of blowing agent, and the specific blowing agent blend. The expansion temperature will generally be in the range of from about 85° C. to 120° C.

The individual foam sheets may be produced with any of the known blowing agents employed in the production traditional foams. Suitable physical blowing agents which may be used alone or in combination include air, carbon dioxide, nitrogen, argon, water, fluorocarbons, chlorofluorocarbons, hydrofluorocarbons, hydrochlorofluorocarbons, alkyl halides, such as methyl chloride and ethyl chloride, and hydrocarbons including methane, ethane, propane, butane, pentane, isopentane, hexane, isohexane, heptane, propane, and isobutane.

Chemical blowing agents which may be used alone or in combination include ammonium and azo type compounds, including ammonium carbonate, ammonium bicarbonate, potassium bicarbonate, diazoaminobenzene, diazoaminotoluene, azodicarbonamide, and diazoisobutyronitrile.

As described in U.S. Pat. No. 5,667,728, an exemplary blowing agent comprises ethane and a different hydrocarbon selected from the group consisting of C_{1 , C}₂, C₃, C₄, C₅, and C₆ alkanes, and mixtures thereof. Typically, ethane should be present in an amount by weight of at least about 40 percent by weight of the total blowing agent. At least 40 percent ethane in the blowing agent substantially reduces flammability as compared to C₃ to C₆ alkanes, promotes desirable nucleation, and can substantially eliminate typical nucleation additives, if desired.

Other alkanes that may be used as blowing agents in the practice of the invention include, but are not limited to, methane, fluorinated ethane, propane, fluorinated propane, the butanes, the pentanes, the hexanes, and mixtures thereof. Fluorinated butane and fluorinated alkanes of higher carbon number are typically of too low volatility to be useful components of the blowing agent according to the invention. However, it should be recognized that minor proportions of these and other alkanes can be present and that the benefits of the invention should still be available.

The blowing agent is mixed into the plasticized polymer resin in proportions to achieve the desired degree of expansion in the resulting foamed cellular product. Stable foam densities from 50 kg/M³ down to as low as 15 kg/M³ may be made by practice of the invention. Stable foams of higher density, up to about 100 kg/M³, can also be produced, if desired. Typically, higher densities are produced by reducing the amount of blowing agent that is mixed with the resin. Densities of from about 20 to 40 kg/m³, and especially from 20 to 30 kg/m³, are somewhat more typical.

In the case of hydrocarbon blowing agents, the blowing agent generally is mixed with the resin in a ratio of about one and one half or one and two tenths parts or less of blowing agent to ten parts of resin. The maximum useful proportion of blowing agent in the plasticized resin is affected by the pressure that is maintained on the resin in the extrusion die passage, as is believed to be well known to the skilled artisan.

Many of the above blowing agents are flammable and present significant handling risks during production of the foam. Because of such risks, it is preferred that lamination not take place until the blowing agents have been allowed to such an extent that the foam is rendered safe for handling. Further, blister formation at the layer interface is avoided by allowing the blowing agents to outgas sufficiently.

Foaming may be enhanced by using a combination of a nucleation agent and an aging modifier to control cell size and development, and to control the replacement of blowing agent with air in the cells of the foam, respectively. In particular, it has been found that a combination of low levels of organic or inorganic nucleation agent, such as zinc oxide or talc, with glycerol monostearate aging modifier is useful to further reduce the density of the foams produced and results in a thickness increase. If chemical blowing agents are used, then the nucleating agent is normally organic such as a mixture of sodium bicarbonate and citric acid, which serves as both a blowing agent and a nucleating agent.

The glycerol monostearate is mixed with the resin prior to melting in an amount sufficient to produce a desirable rate of exchange of air with blowing agent in the cells of the foam. Glycerol monostearate may be added in an amount of about 0.3 to 1.5 kg per 100 kg of LDPE resin, which is mixed with the resin prior to melting.

Nucleation agent is optionally mixed with the resin in an amount sufficient to promote increased nucleation and to develop a pore structure of the desired size. Nucleation agent is mixed with the resin in an amount of from about 0.05 to 0.5 kg per 100 kg of resin. Zinc oxide or talc may be added to the resin in an amount of 0.1 kg per 100 kg of resin.

In addition to the polyethylene resin, blowing agent, nucleation agent, and any aging modifier, the mixtures for forming the foam sheets may include one or more additives including elastomeric components such as polyisobutylene, polybutadiene, and ethylene-propylene rubber, cross-linking agents, extrusion aids, antioxidants, colorants, pigments, antimicrobial agents, UV stabilizers, antistatic agents, biostabilizers, flame retardants, and permeability modifiers such as esters and amides of fatty acids.

The resin is extruded through a die to an environment of atmospheric pressure. The width of the die determines the resulting thickness of the foam sheet. The die is preferably an annular sheet die with a diameter greater than 3 inches. As the mixture is extruded to a zone of lower pressure, the blowing agent expands to form a foam cylinder that is sliced with a single slit along the bottom of the foam to form sheet. The foam sheet has a top surface and a bottom surface generally parallel to the top surface and a plurality of pores or cells dispersed throughout the polymer matrix. Immediately after cell formation, the cells are filled almost entirely with the blowing agent.

After extrusion, the foam is allowed to cool and blowing agent is allowed to escape from the foam, usually for a number of days. The foam is preferably cooled at room temperature. The foam may be perforated to allow for faster evacuation of the blowing agent from the foam. Fast evacuation of the blowing agent is favorable because effective lamination is hampered by the presence of significant amounts of blowing agent remaining within the foam.

The thick-sheet laminate is produced from the foam sheets by heat-laminating the sheets to one another. In one manner of heat laminating the foam sheets, the foam sheets are fed together with pressure exerted by two turning rollers. Immediately prior to the materials meeting in the nip of the rollers, heat is applied to the surfaces which are about to be pressed together. The heat can be supplied by hot air guns, infrared heaters, or a combination thereof. Heat can be applied to both foam sheets or only to one. The heat makes the surface of the foam sheet tacky by creating local regions of melting on the surface. The foam sheets passing through the rollers nip are joined by a bond upon cooling.

When the laminate comprises more than two layers, the above lamination method may be employed in any order for combining the various sheets. It is preferred to laminate one sheet at a time, or to laminate together two laminates of two or more laminated sheets. It is, however, also possible to laminate all the foam sheets together simultaneously. Lamination can be made in batch, to provide thick planks of a desired size, or continuously to provide roll stocks of laminate. It is preferred that the foam layers of the laminate have a similar density because heat lamination is particularly effective for bonding foam sheets of a similar density. By similar density, it is meant that the density of the laminate layers vary by less than about 8%.

The foam layers are described in terms of nominal thickness. Each foam layer with a nominal ¾-inch thickness or more is normally produced with a thickness tolerance of ±5%. The foam may lose up to an additional 5% of thickness upon lamination. Thicker foams of about 1-inch or more can be produced with a thickness tolerance of up to ±8%.

The thick-sheet laminates have at least one, and preferably several foam layers with a thickness of about ¾-inch or greater to form a laminate with a total thickness of 1½-inch to about 10 inches. Whereas compression characteristics generally increase with individual layer thicknesses and with the number of thick layers within the laminate, it is preferred that multiple layers within the laminate have thickness of ¾-inch or greater. One-inch foam layers are advantageously used to produce laminates having a total thickness of 2 inches and greater, and 1½-inch foam layers are advantageously used to produce laminates having a total thickness of 3 inches and greater.

Each of the layers of the laminate is formed from polyethylene resin and has a density essentially the same as the other foam layers of the laminate. The thick-sheet laminate may be bonded or further laminated to other foams and materials, and may be used as a core for multi-component foam products. For instance, a thick-sheet laminate core may be laminated between two high-density foam skins to form a unitary foam article having favorable compression characteristics imparted by the laminated core and physical toughness imparted by the high-density foam skins.

The advantages in compressive strength and initial loading characteristics of foams produced in accordance with the above disclosure are particularly demonstrated by the Examples below.

### EXAMPLES

### Example 1

### Preparation of 2 inch Laminate from ½-inch Laminated Polyethylene Foam

LDPE pellets were supplied to the melting zone of a counter-rotating twin screw extruder maintained at about 300 to 310° F. The resin had a flow rate of 409.1 kg/hr. Melting and mixing occurred in the primary single screw extruder at a melt temperature of 228.3° F. A butane blowing agent was supplied to the mixture at 42.05 kg/hr. A glycerol monostearate aging control additive was mixed with the resin at a rate of about 4.91 kg/hr. A 3.52 kg/hr of 50% active talc masterbatch was added to nucleate fine cells.

The resin was extruded through an annular die at a die pressure of 350 psi to an atmospheric pressure environment and allowed to expand to form a foam cylinder which was immediately slit lengthwise along the underside of the cylinder to form a foam sheet. The resulting foam was found to have a density of 1.65 lbs/ft³ when hot, 1.70 lbs/ft³ after cooling, and an average medium foam cell size. The foam sheet was then cut into ½-inch foam sheets that were partially perforated to allow for exchange of blowing agent. The percentage of open cells in the ½-inch foam was about 62% as determined by ASTM D2856-87.

Referring to FIG. 3, after curing at room temperature for a time sufficient to reduce residual blowing agent below the lowest explosive limit, two roll stocks of the ½-inch foam sheets obtained as above were heat-laminated. Hot air was injected between the two sheets that were then pressed together between nip rolls to heat laminate the sheets. This heat-lamination procedure was then repeated using two of the 2-ply foam laminates formed by the preceding step, resulting in a single heat-laminated foam structure having four layers 32, 34, 36, 38 joined together at interfaces 33, 35, 37, with a total thickness of approximately 2 inches.

The laminate was tested with ASTM D3575D, Suffix BB at a compressive loading of 2 psi for 168 hours. Creep was 15.92%.

### Example 2

### Preparation of 2-inch Laminate from 1.05-inch Laminate Polyethylene Foam

LDPE pellets were supplied to the melting zone of a counter-rotating twin screw extruder maintained at about 300 to 315° F. The resin had a flow rate of 503.6 kg/hr. Melting and mixing occurred in the primary single screw extruder at a melt temperature of 232° F. A butane blowing agent was supplied to the mixture at 49.59 kg/hr. A glycerol monostearate aging control additive was mixed with the resin at a rate of about 3.18 kg/hr. A 3.63 kg/hr of 50% active talc masterbatch was added to nucleate fine cells.

The resin was extruded through an annular die at a die pressure of 354 psi to an atmospheric pressure environment and allowed to expand to form a foam cylinder which was immediately slit lengthwise along the underside of the cylinder to form a foam sheet. The resulting foam was found to have a density of 1.65 lbs/ft³ when hot, 1.70 lbs/ft³ after cooling, and an average medium foam cell size. The foam sheet was then cut into nominal 1-inch foam sheets which were partially perforated to allow for exchange of blowing agent. The percentage of open cells in the nominal 1-inch foam was about 21% as determined by ASTM D2856-87.

Referring to FIG. 4, after curing at room temperature for a time sufficient to reduce residual blowing agent below the lowest explosive limit, two roll stocks of the nominal 1-inch foam sheets obtained as above were heat-laminated. Hot air was injected between the two sheets which were then pressed together between nip rolls to heat laminate the sheets, resulting in a single heat-laminated foam structure having two layers 42, 44 bound together at an interface 43, and having a total thickness of just less than 1.94 inches.

The laminate was tested with ASTM D3575D, Suffix BB at a compressive loading of 2 psi for 168 hours. Creep was 12.78%.

### Example 3

### Comparison of Compression Strength

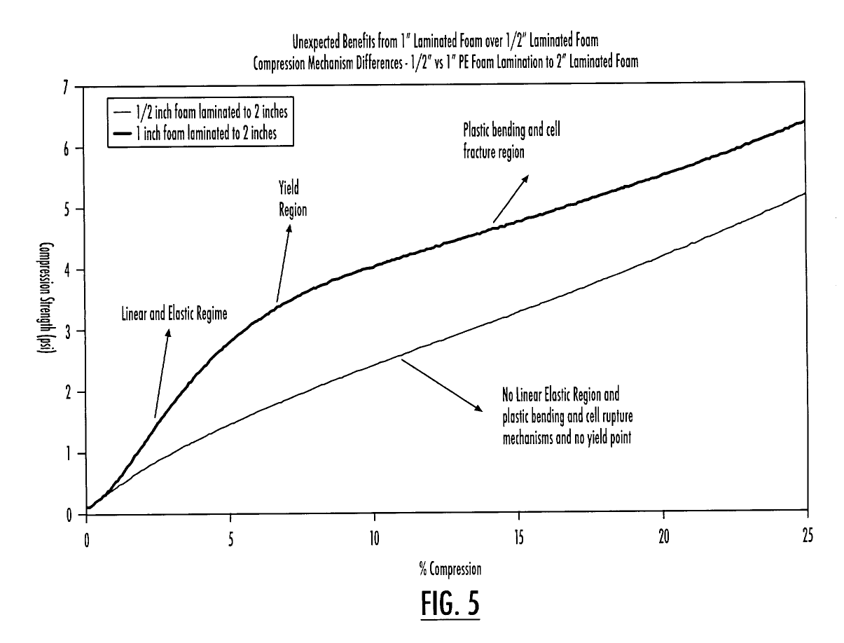

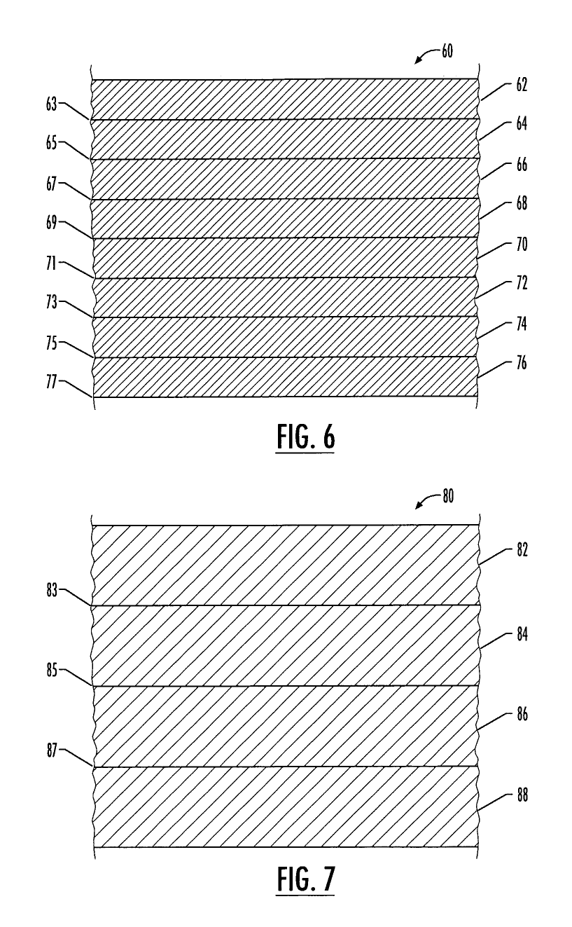

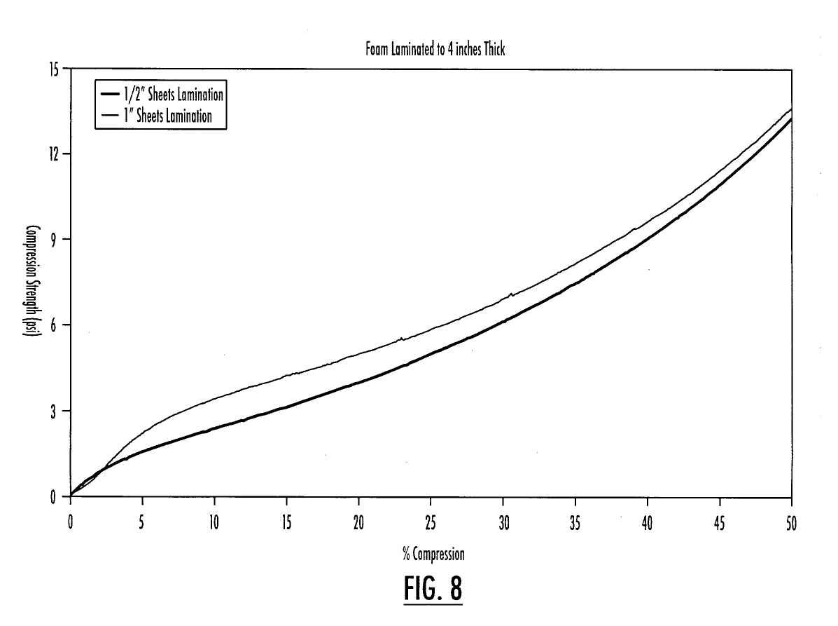

The foams laminates of Examples 1 and 2 were subjected to compression tests according to ASTM D3575-93, Suffix D. As shown in Table 1 and graphically illustrated in FIG. 5, the 2-inch laminate formed from the 1-inch foam layers has substantially better compressive strength than the comparable foam laminate formed from 2-inch foam layers. Further, the initial increasing slope (elastic slope) of the % compression vs. compression strength curve of FIG. 5 indicates that the 1-inch foam laminate has linear and elastic behavior upon initial loading up to a yield point at about 7.5% compression, while the generally decreasing slope of the initial region of the ½-inch laminate indicates that the ½-inch laminate has no region of elastic deformation.

TABLE 1

| | | | Compression | Compression | Compression | Compression |
|---|---|---|---|---|---|---|
| | Foam | Foam | Strength @ | Strength @ | Strength @ | Strength @ |
| | Density, | Thickness, | 5% | 10% | 25% | 50% |
| Foam | pcf | inches | Compression | Compression | Compression | Compression |
| ½″ Laminated | 1.70 | 2.077″ | 1.64 psi | 2.67 psi | 5.51 psi | 13.85 psi |
| PE foam | | | | | | |
| ˜1″ Laminated | 1.61 | 2.087″ | 2.83 psi | 4.22 psi | 6.7 psi | 14.72 psi |
| PE foam | | | | | | |
| % | 5.9% | N/A | 72.6% | 58.1% | 21.6% | 6.3% |
| Improvement | lighter | | | | | |

### Examples 4

### Preparation of 4-inch Laminate from ½-inch Laminated Polyethylene Foam

Two 2-inch laminate sheets were obtained as taught in Example 1. Referring to FIG. 6, the two laminates were heat laminated, as taught in Example 1 to produce a 4-inch laminate comprising eight sheets of ½-inch LDPE foam 62, 64, 66, 68, 70, 72, 74, 76 and bonded interfaces 63, 65, 67, 69, 71, 73, 75, 77 between the foam sheets.

### Example 5

### Preparation of 4-inch Laminate from 1-inch Laminated Polyethylene Foam

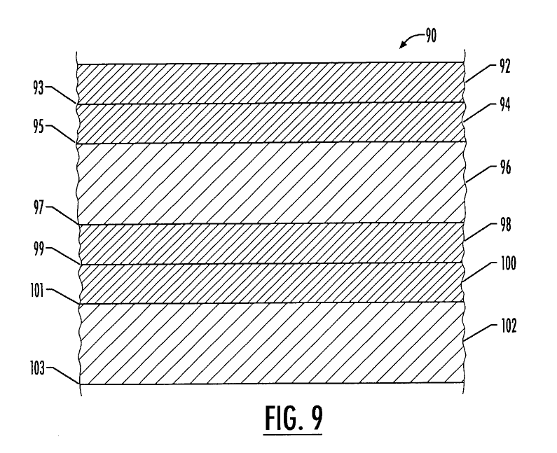

Two 2-inch laminate sheets were obtained as taught in Example 2. Referring to FIG. 7, the two laminates were heat laminated, as taught in Example 2 to produce a 4-inch laminate comprising four sheets of 1-inch LDPE foam 82, 84, 86, 88 and bonded interfaces 83, 85, 87 between the foam sheets.

### Example 6

### Comparison of Compression Strength

The foams laminates of Examples 4 and 5 were subjected to compression tests according to ASTM D3575-93, Suffix D. As graphically illustrated in FIG. 8, the 4-inch laminate formed from 1-inch foam layers has substantially better compressive strength than the comparable foam laminate formed from ½-inch foam layers. Further, the initial increasing slope of the % compression vs. compression strength curve of FIG. 8 indicates that the 1-inch foam laminate has linear and elastic behavior upon initial loading up to a yield point of about 5% compression, while the generally decreasing slope of the initial region of the ½-inch laminate indicates that the ½-inch laminate has no region of elastic deformation.

### Example 7

### Preparation of 4-inch Laminate from 1-inch and ½-inch Polyethylene Foam

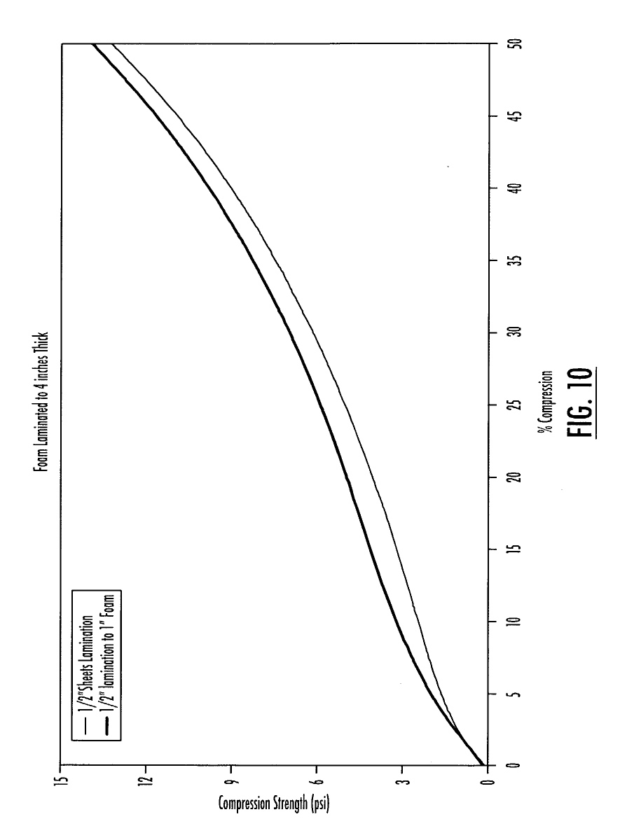

Two sheets of 1-inch LDPE foam were prepared as in Example 2, and four sheets of ½-inch LDPE foam were prepared as in Example 1. The two 1-inch sheets 96, 102 and the four sheets 92, 94, 98, 100 were heat laminated to one another using the heat-laminating process of Example 1 to form bonded interfaces 93, 95, 97, 99, 101, 103 between the foam sheets as shown in FIG. 9.

### Example 8

### Comparison of Compression Strength

The foams laminates of Examples 4 and 7 were subjected to compression tests according to ASTM D3575-93, Suffix D. The resulting graph is shown in FIG. 10. As graphically in FIG. 10, the 4-inch laminate formed from 1-inch foam layers has substantially better compressive strength than the comparable foam laminate formed from two 1-inch layers and four ½-inch foam layers. Further, the initial linear slope of the % compression vs. compression strength curve of FIG. 10 indicates that both of the laminates have linear and elastic behavior upon initial loading. The 1-inch laminate had a yield point at about 5% compression while the combined ½-inch/1-inch laminate had a yield point at about 2.5% compression.

### Example 9

### Preparation of 6-inch Laminate from ½-inch Laminated Polyethylene Foam

Twelve sheets of ½-inch LDPE foam were prepared as in Example 1. Referring to FIG. 11, the twelve sheets 112 were heat laminated to one another as in Example 1 to form bonded interfaces 113 between the foam sheets.

### Example 10

### Preparation of 6-inch Laminate from 1-inch Laminated Polyethylene Foam

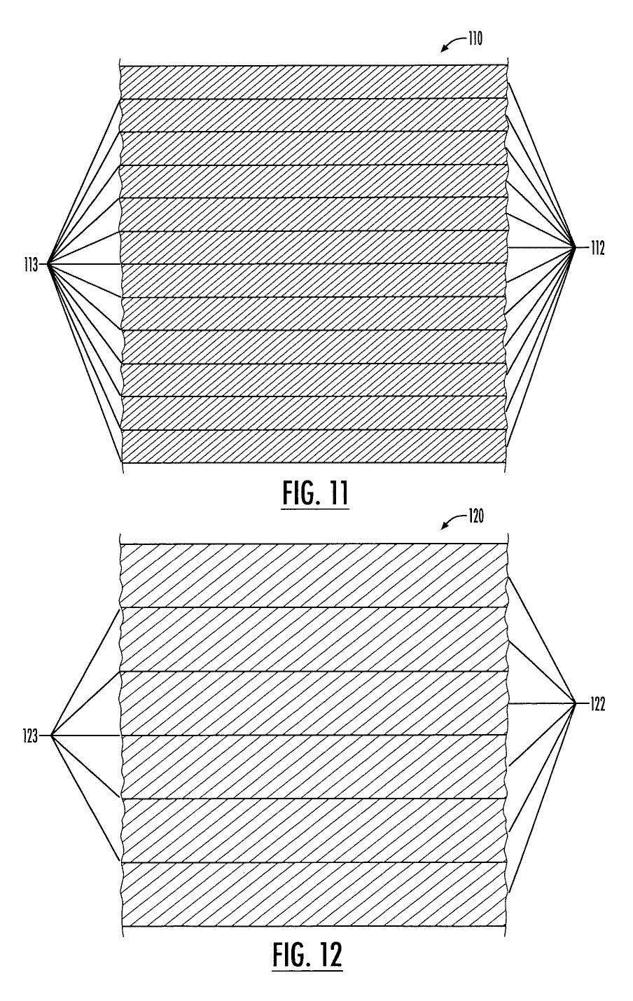

Six sheets of 1.05-inch LDPE foam were prepared as in Example 2. Referring to FIG. 12, the four sheets 122 were heat laminated to one another as in Example 2 to form bonded interfaces 123 between the foam sheets.

### Example 11

### Comparison of Compression Strength

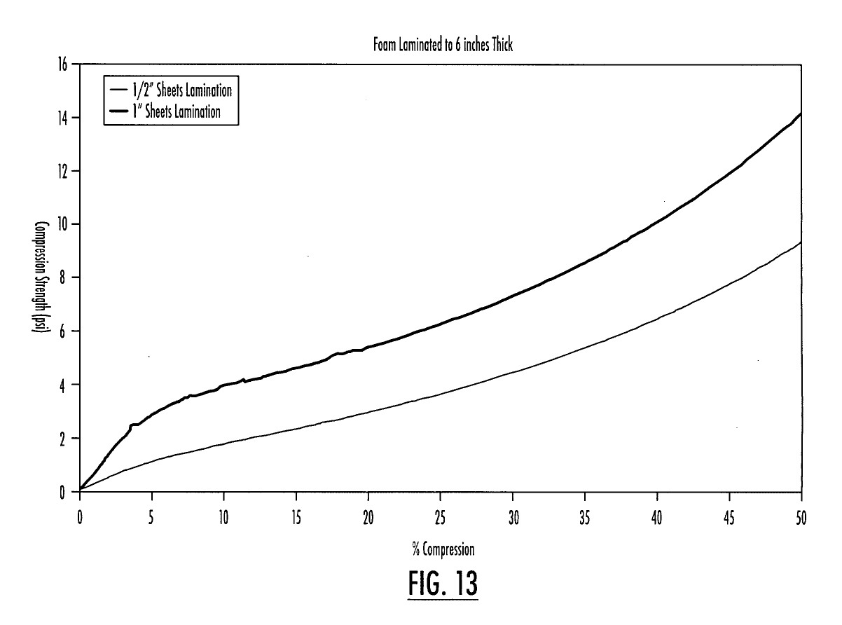

The foams laminates of Examples 9 and 10 were subjected to compression tests according to ASTM D3575-93, Suffix D. As graphically illustrated in FIG. 13, the 6-inch laminate formed from 1-inch foam layers has substantially better compressive strength than the comparable foam laminate formed from ½-inch foam layers. Further, the initial increasing slope of the % compression vs. compression strength curve of FIG. 13 indicates that the 1-inch foam laminate has linear and elastic behavior upon initial loading up to a yield point of about 5% compression, while the low slope of the initial region of the ½-inch laminate indicates that the ½-inch laminate has no region of elastic deformation.

Comparison of the results shown in FIG. 13 with those obtained in Example 8 and shown in FIG. 8 demonstrates that the beneficial gains in laminate compressive strength increases with the thickness of the laminate. For instance, the 4-inch laminate of 1-inch sheets showed a substantial increase in compressive strength over the 4-inch laminate of ½-inch sheets, however the 6-inch laminate of 1 -inch sheets showed an even more substantial increase in compressive strength compared to the 6-inch laminate of ½-inch sheets.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A foam laminate comprising
a first foam layer with a thickness of greater than or equal to about ¾-inches; and,
a second foam layer heat-laminated to the first foam layer;
wherein said first and second layers are a polyethylene homopolymer or copolymer and said laminate exhibits linear-elastic compression upon initial loading.

2. The foam laminate of claim 1, wherein the foam laminate has a total thickness of about 1½ to 10 inches.

3. The foam laminate of claim 1, wherein the first and second foam layers have a similar density.

4. The foam laminate of claim 1, further comprising at least one additional heat-laminated foam layer, each of which has a thickness of greater than or equal to about ¾-inches.

5. The foam laminate of claim 4, wherein the first layer has a thickness of 1-inch and greater.

6. The foam laminate of claim 5, wherein the first layer has a thickness of 1½-inch and greater.

7. The foam laminate of claim 1, wherein the first and second layers comprise a resin selected from the group consisting of low-density polyethylene (LDPE); linear low-density polyethylene (LLDPE); high-density polyethylene (HDPE); metallocene/single-site catalyzed copolymers of ethylene and one or more C₃ to C₁₀ alpha-olefin comonomers; heterogeneous Ziegler-Natta catalyzed ethylene/alpha-olefin copolymers; and ethylene copolymers of propylene, higher olefins, carboxylic acids, or esters.

8. The foam laminate of claim 7, wherein the first and second layers comprise LDPE.

9. The foam laminate of claim 7, wherein the first and second layers comprise ethylene vinyl acetate copolymers with vinyl acetate content of up to 30 wt %.

10. The foam laminate of claim 8, wherein the first and second layers further comprise an additive selected from the group consisting of aging modifiers, nucleating agents, elastomeric components, cross-linking agents, extrusion aids, antioxidants, colorants, pigments, permeability modifiers, antimicrobials, UV stabilizers, antistatic agents, biostabilizers, flame retardants, and combinations thereof.

11. The foam laminate of claim 10, wherein the aging modifier is glycerol monostearate.

12. The foam laminate of claim 10, wherein the nucleating agent is selected from inorganic and organic nucleating agents.

13. The foam laminate of claim 12, wherein the nucleating agent is selected from the group consisting of zinc oxide, talc, and mixtures of sodium bicarbonate and citric acid.

14. The foam laminate of claim 1, wherein the laminate exhibits linear-elastic compression at greater than 7.5% compression.

15. The foam laminate of claim 14, wherein the laminate exhibits linear-elastic compression greater than 0% and less than 7.5% compression.

16. The foam laminate of claim 15, wherein the laminate exhibits linear-elastic compression greater than 0% and less than 5% compression.

17. The foam laminate of claim 1, further comprising a skin layer with a higher density than said first and second layers, laminated to the laminate about its outer surface.

18. The foam laminate of claim 1, wherein the density of the first and second foam layers is between 1.2 lbs/ft³ and 7.5 lbs/ft³.

19. The foam laminate of claim 1, wherein the first and second foam layers comprise LDPE foam, and
wherein the first and second foam layers have a similar density between 1.2 lbs/ft³ and 7.5 lbs/ft³.

20. A foam laminate comprising
at least two layers of foam heat laminated to one another,
wherein the at least two layers each have a thickness of ¾-inch or greater and wherein the at least two layers are polyethylene homopolymers or copolymers of substantially the same density.

21. The laminate of claim 20, wherein the at least two layers are LDPE.

22. The laminate of claim 20, wherein the at least two layers are ethylene vinyl acetate copolymers with vinyl acetate content ranging up to 30 wt %.

23. The laminate of claim 20, wherein the at least two layer of foam have a thickness of about 1 inch.

24. A method of preparing a foam laminate comprising the steps of
providing a first foam layer selected from the group consisting of a polyethylene homopolymer and copolymer foam, with a first density and a thickness greater than ¾-inch; and,
providing a second foam layer selected from the group consisting of a polyethylene homopolymer and copolymer foam, with a second density; and,
heat-laminating the first foam layer to the second foam layer.

25. The method of claim 24, wherein the first density and the second density are similar.

26. The method of claim 24, wherein the foam laminate has a total thickness of about 1½ to about 10 inches.

27. The method of claim 24, further comprising the steps of
providing at least one additional foam layer, each having a thickness greater than ¾-inch, and
laminating the at least one additional foam layer to the laminate formed of the first and second layers.

28. The method of claim 24, wherein the first and second layers comprise LDPE foam.

29. The method of claim 28, wherein the first and second LDPE layers comprise an additive selected from the group consisting of aging modifiers, nucleating agents, elastomeric components, cross-linking agents, extrusion aids, antioxidants, colorants, pigments, permeability modifiers, and combinations thereof.

30. The method of claim 29, wherein the aging modifier is glycerol monostearate.

31. The method of claim 29, wherein the nucleating agent is selected from zinc oxide and talc.

32. The method of claim 24, wherein the first and second layers comprise ethylene vinyl acetate copolymers with vinyl acetate content ranging up to 30 wt %.

33. A method of preparing a low density polyethylene (LDPE) foam laminate comprising the steps of
providing at least two layers of LDPE foam, each having a thickness greater than ¾-inch and each having substantially the same density; and
heat laminating the at least two layers to one another.

34. The method of claim 33, wherein the at least two layers have thickness of about 1-inch.
